(19) United States
(12) Patent Application Publication
(10) Pub. No.: US 2019/0007337 A1
(43) Pub. Date: Jan. 3, 2019

(54) DEVICE AND METHOD FOR MANAGING END-TO-END CONNECTIONS OF A NETWORK WITHIN A CENTRAL NETWORK MANAGEMENT ENTITY

(71) Applicants: Jochen GUCK, München (DE); Wolfgang KELLERER, Fürstenfeldbruck (DE); Vivek KULKARNI, Unterhaching (DE); Johannes RIEDL, Ergolding (DE)

(72) Inventors: Jochen GUCK, München (DE); Wolfgang KELLERER, Fürstenfeldbruck (DE); Vivek KULKARNI, Unterhaching (DE); Johannes RIEDL, Ergolding (DE)

(21) Appl. No.: 15/748,598

(22) PCT Filed: Jul. 30, 2015
(86) PCT No.: PCT/EP2015/067544

§ 371 Date: Jan. 29, 2018

(51) Int. Cl. H04L 12/917; H04L 12/801; H04L 12/725

(52) U.S. Cl. CPC H04L 47/76; H04L 65/80; H04L 45/302; H04L 47/18

(57) ABSTRACT

Managing end-to-end connections of a network includes estimating a load of network resources, and providing a quality of service status of the network. Quality of service parameters within the network are pre-calculated based on the load of the network resources and the quality of service status of the network, and the network resources are pre-allocated based on the pre-calculated quality of service parameters. Data packets are routed based on the pre-allocated network resources.

This application is the National Stage of International Application No. PCT/EP2015/067544, filed Jul. 30, 2015. The entire contents of this document are hereby incorporated herein by reference.

### BACKGROUND

The present embodiments relate to managing end-to-end connections of a network within a central network management entity.

A logically centralized network controller may control networks (e.g., by a distributed control plane managing several forwarding devices). In such networks, the network state (e.g., bandwidth, latency, buffer utilization, etc.) may be collected from a forwarding plane, and a centralized routing of data packets may be based on the network state information.

There are typically a large number of communication service requests that are to be addressed by such a network control. Every realization of such a service changes the network state and, in case of an immediately following service request, the service may suffer due to temporary inconsistency of network states in the controller and the network. This procedure may, however, not be fast enough, may not scale, and may not be suitable for industrial networks fulfilling specific multiple constraint (e.g., maximum delay, etc.) requirements.

In some network types, several middleware layer and interface architectures are used for adaptive quality of service (QoS) control that exploit real-time scheduling approaches. These architectures involve a control loop that is closed over the forwarding and control planes. Closed loop control over both the forwarding and control planes may introduce delays and measurement errors that are difficult to correct. Therefore, it may be difficult to achieve a fast and accurate QoS control.

A state of the network contains the actual QoS situation of the network. The state of the network contains all per hop parameter and all end-to-end parameters that are to be used for the QoS calculations. Some network systems take requests from the network and handle the requests by using the latest network state for the routing decision. However, the used state of the network has some limitations. The state is to be either constructed by polling all network devices or collecting broadcasted network information. However, this may lead to a time inconsistency and a time offset of the values.

Existing network systems are either pre-planned or inherit time-inconsistency as mentioned in the following steps: 1) While adding a new flow, the routing algorithm finds the suitable path based on the network state; 2) The network state and related update is collected and/or polled by a network monitor in the control plane; 3) If there is a feasible path, this new flow will be embedded in the forwarding plane of the network. However, based on these steps, delay guarantees on the fly are difficult to provide.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a network management able to provide delay guarantees during changes of a network structure is provided.

According to a first aspect, a device for managing end-to-end connections of a network within a central network management entity is provided. The network includes a plurality of network resources. The device includes a modeling unit (e.g., a modeler) for estimating a load of the network resources and a state unit for providing a quality of service status of the network. The device also includes a resource allocation unit (e.g., a resource allocator) for pre-calculating quality of service parameters within the network based on the load of the network resources and the quality of service status of the network, and for pre-allocating the network resources based on the pre-calculated quality of service parameters. The device also includes a routing unit (e.g., a router) for routing data packets based on the pre-allocated network resources. The modeling unit, the state unit, and the resource allocation unit form a first loop, and the modeling unit, the state unit, and the routing unit form a second loop.

The respective unit (e.g., the modeling unit) may be implemented in hardware and/or in software. If the unit is implemented in hardware, the unit may be embodied as a device (e.g., as a computer or as a processor or as a part of a system such as a computer system). If the unit is implemented in software, the unit may be embodied as a computer program product, as a function, as a routine, as a program code, or as an executable object.

Based on the device of one or more of the present embodiments, a smart mechanism may be employed for managing end-to-end connections with quality of service (QoS) guarantees in a central network management entity for steering the network to provide the QoS guarantees. The central network management entity may be, for example, an SDN (software defined networking) controller.

By splitting the overall routing into a routing unit and a corresponding loop, and a resource allocation unit and a corresponding loop, the complexity of routing may be reduced. This split enables the routing of data packet flows with end-to-end QoS constraints like delay, loss, etc. by having a moderate computational complexity and a deterministic response time. This is the case as two algorithms may be used, one for the routing unit and the corresponding loop and one for the resource allocation unit and the corresponding loop.

As the routing unit and the corresponding loop work parallel to the resource allocation unit, a dynamic setup of delay constraint communication services may be enabled during runtime. The routing unit may define a path within the network using the existing resource allocation, and at the same time, the resource allocation unit may adapt the resource allocation if necessary. Such a dynamic adaptation of changes within the network structure may be needed by industry automation applications.

Pre-allocating the network resources based on the pre-calculated quality of service parameters may refer to the fact that the resource allocation unit selects network resources (e.g., network elements and links between the network elements) for providing a connection having specific QoS parameters.

Communication services in this context may refer to any services that have specific QoS requirements. These requirements may be, for example, delay, loss, or jitter of any data packets of the respective communication service. The routing unit handles these communication services and corresponding communication requests.

According to an embodiment, the modeling unit, the state unit, the resource allocation unit, and the routing unit are located in a control plane of the network.

As a basis, instead of a control loop that is closed over the forwarding and control planes, the control loops are kept within the control plane. Thus, low cost commodity hardware may be used in the forwarding plane (e.g., the plane being responsible for forwarding data packets within the network), as the forwarding plane does not need to provide a complex functionality.

According to a further embodiment, the resource allocation unit is adapted to pre-allocate the network resources by distributing available network resources of at least one link within the network to queues of the at least one link, where each of the queues includes data packets to be transmitted collectively.

Instead of a control loop that is closed over the forwarding and control planes, a queue-link model is used to keep the control loop within the control plane. Queue-link model may denote that data packets to be transmitted collectively are arranged in queues. Each queue has a specific QoS behavior. One or more queues are assigned to one link. The resource allocation unit decides which network resources of this link are to be used by which queue. This may result in a change of the QoS behavior of the respective queue.

According to a further embodiment, the state unit is adapted to calculate a worst case delay for each queue.

Based on the information of the link, the state unit may calculate the delay for each queue and thus also a worst case delay. Based on this initial state, the routing unit may find routes that fulfill the deadline requirements of the communication service (e.g., the data packets).

According to a further embodiment, the routing unit is adapted to route data packets based on the pre-allocated network resources taking into account quality of service requirements of the data packets.

The routing unit may select a path for the data packets based on the allocated network resources as well as on actual QoS requirements of the data packets.

According to a further embodiment, the resource allocation unit is adapted to update the pre-allocation of the network resources when new links are added to the network and/or existing links are removed and/or when the data packets to be transmitted changes.

Thus, the resource allocation unit may react to changes of the network to dynamically adapt the pre-allocated network resources. Such changes may include changes of the network structure itself but also changes of the data packets to be transmitted (e.g., the demand for network links or changes of the QoS requirements of the data packets to be transmitted).

According to a further embodiment, the modeling unit is adapted to estimate the load of the network resources based on information from the routing unit and based on information from the resource allocation unit.

Both pre-allocated resources and actual data packets may thus be used for estimating the load of the network.

According to a further embodiment, the information from the routing unit includes information on paths being used for the data packets within the network.

Thus, the actual network situation (e.g., used paths and data packets) may be taken into account.

According to a further embodiment, the information from the resource allocation unit includes information on allocated resources.

Thus, available network resources may be taken into account when calculating the load of the network.

According to a further embodiment, the routing unit is adapted to determine a path for the data packets to be routed by minimizing the cost of a path from origin to destination while fulfilling the quality of service requirements of the data packets from origin to destination.

In this embodiment, the QoS requirements for the complete path may be taken into account.

According to a further embodiment, the quality of service requirements of the data packets from origin to destination are end-to-end quality of service requirements.

Each data packet may have QoS requirements that are to be fulfilled from the start point to the end point of the transmission of the data packets.

According to a further embodiment, the routing unit is adapted to determine the path for the data packets to be routed by minimizing the cost of the path from origin to destination while fulfilling the quality of service requirements of the data packets for each hop from origin to destination.

In addition, QoS requirements may be taken into account for each hop. This provides a more detailed QoS overview and improves the fulfillment of the QoS requirements.

According to a further embodiment, the quality of service requirements of the data packets for each hop from origin to destination are per hop quality of service requirements.

For each hop (e.g., for each transmission between two network elements), QoS requirements may be fulfilled.

Any embodiment of the first aspect may be combined with any embodiment of the first aspect to obtain another embodiment of the first aspect.

According to a second aspect, a method for managing end-to-end connections of a network within a central network management entity is provided. The network includes a plurality of network resources. The method includes estimating a load of the network resources, providing a quality of service status of the network, and pre-calculating quality of service parameters within the network based on the load of the network resources and the quality of service status of the network. The method also includes pre-allocating the network resources based on the pre-calculated quality of service parameters, and routing data packets based on the pre-allocated network resources. The estimating, the providing, the pre-calculating, and the pre-allocating, form a first loop, and the estimating, the providing, and the routing form a second loop.

According to a further aspect, one or more of the present embodiments relate to a computer program product including a program code for executing the above-described method for managing end-to-end connections of a network within a central network management entity when run on at least one computer.

A computer program product, such as a computer program, may be embodied as a memory card, USB stick, CD-ROM, DVD (e.g., a non-transitory computer-readable storage medium) or as a file that may be downloaded from a server in a network. For example, such a file may be provided by transferring the file including the computer program product from a wireless communication network.

The embodiments and features described with reference to the device of the present embodiments apply to the method of the present embodiments.

Further possible implementations or alternative solutions also encompass combinations, which are not explicitly mentioned herein, of features described above or below with regard to the embodiments. The person skilled in the art may also add individual or isolated aspects and features to the most basic form of the present embodiments.

### BRIEF DESCRIPTION OF THE DRAWINGS

FIG. 1 shows a schematic block diagram of one embodiment of a device for managing end-to-end connections of a network within a central network management entity;

FIG. 2 shows a schematic flow diagram illustrating exemplary processes within a resource allocation unit of the device of FIG. 1;

FIG. 3 shows a schematic flow diagram illustrating exemplary processes within a routing unit of the device of FIG. 1; and

FIG. 4 shows a sequence of methods acts of one embodiment of a method for managing end-to-end connections of a network within a central network management entity.

### DETAILED DESCRIPTION

In the Figures, like reference numerals designate like or functionally equivalent elements, unless otherwise indicated.

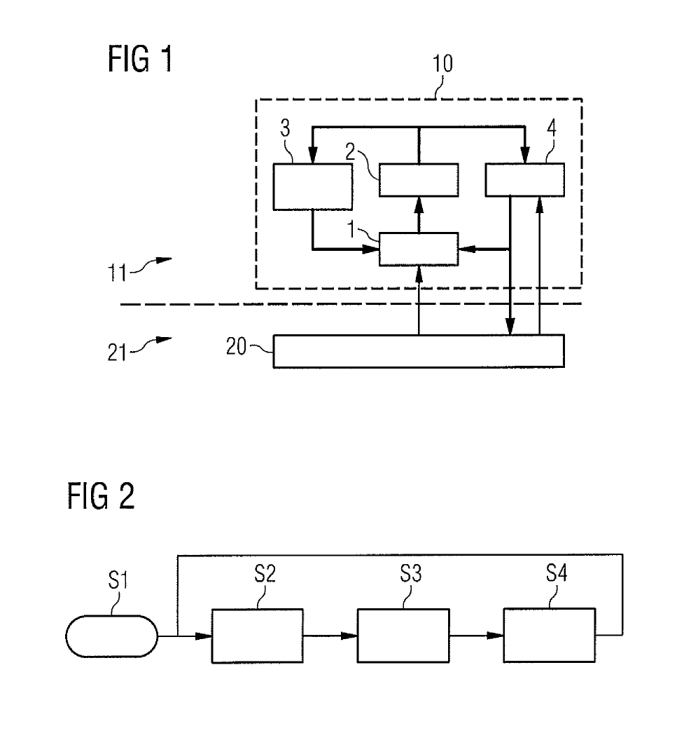

FIG. 1 shows one embodiment of a device 10 for managing end-to-end connections of a network 20. The device 10 may be part of a central network management entity.

The device 10 includes a modeling unit 1, a state unit 2, a resource allocation unit 3, and a routing unit 4. All four units 1, 2, 3 and 4 are arranged within a control plane 11, where the network itself provides a forwarding plane 21. Thus, the network 20 may be less complex as the control is completely arranged within the control plane 11.

The modeling unit 1, the state unit 2, and the resource allocation unit 3 form a first loop. The modeling unit 1, the state unit 2 and the routing unit 4 form a second loop.

The modeling unit 1 estimates a load of the network resources. The modeling unit 1 receives an input from the network 20 itself, the resource allocation unit 3, and the routing unit 4.

The state unit 2 provides a quality of service status of the network 20. This is done based on information from the modeling unit 1.

The resource allocation unit 3 pre-calculates quality of service parameters within the network 20 based on the load of the network resources and the quality of service status of the network and pre-allocates the network resources based on the pre-calculated quality of service parameters.

The routing unit 4 routes data packets based on the pre-allocated network resources.

FIG. 2 shows an example of the processes within the resource allocation unit 3.

In act S1, the algorithm within the resource allocation unit 3 starts.

In act S2, the resource allocation unit 3 takes one physical link of the network 20.

In act S3, the resource allocation unit 3 finds a better resource allocation of the taken physical link for the actual data packets within the network 20.

In act S4, the resource allocation unit 3 performs a new resource allocation if the network 20 changes, for example, when links are added or removed.

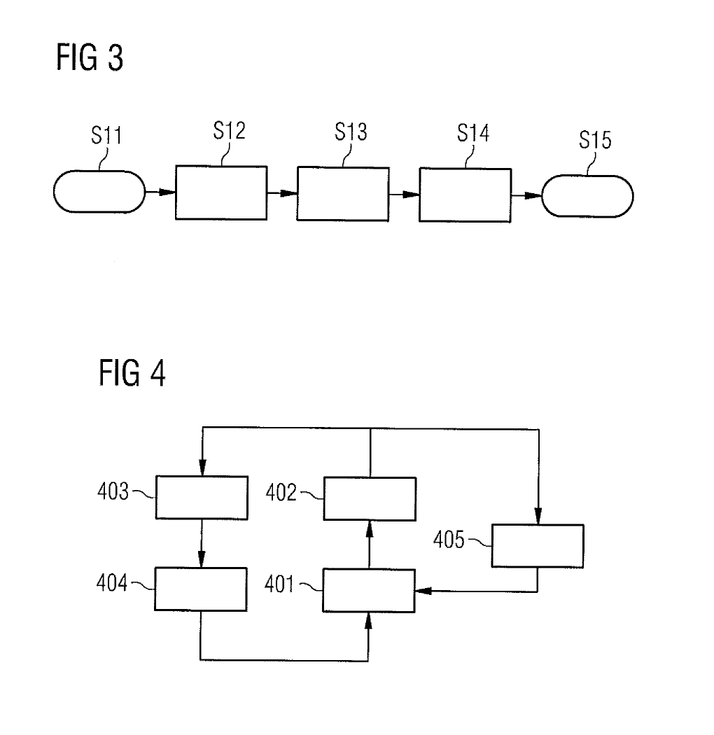

FIG. 3 shows an example of the processes within the routing unit 4.

In act S11, the algorithm of the routing unit 4 starts.

The routing problem for a connection corresponds to a delay constraint least cost routing problem, which may be formulated to minimize the cost of a path from origin to destination subject to the path QoS constraints meeting the end-to-end constraints. In the device 10, constraints that check per hop constraints are added. If an edge (e.g., of the network graph) does not fulfill the per hop constraint, the corresponding edge will be disabled for the delay constraint least cost routing algorithm. Thus, the routing algorithm may manage per hop and end-to-end constraints. In one embodiment, this approach may be used for routes that use other end-to-end constraints such as, for example, packet loss instead of delay.

In act S12, edges that have less resources to fulfill the QoS requirements are reduced from the graph.

In act S13, the above-described routing algorithm is run.

In act S14, a resource utilization counter is updated. This counter shows how many of the available resources are used.

In act S15, the routing algorithm ends.

The information from the processes shown in FIGS. 2 and 3 may then be used for the modeling unit 1 to improve the model of the network 20.

FIG. 4 shows a method for managing end-to-end connections of a network 20 within a central network management entity. The method includes the acts 401-405.

In act 401, a load of the network resources is estimated.

In act 402, a quality of service status of the network 20 is provided.

In act 403, quality of service parameters within the network 20 are pre-calculated based on the load of the network resources and the quality of service status of the network 20.

In act 404, the network resources are pre-allocated based on the pre-calculated quality of service parameters.

In act 405, data packets are routed based on the pre-allocated network resources.

As shown in FIG. 4, the estimating act 401, the providing act 402, the pre-calculating act 403, and the pre-allocating act 404 form a first loop, and the estimating act 401, the providing act 402 and the routing act 405 form a second loop.

Although the present invention has been described in accordance with exemplary embodiments, it is obvious for the person skilled in the art that modifications are possible in all embodiments.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A device for managing end-to-end connections of a network within a central network management entity, the network including a plurality of network resources, the device comprising:
a modeler configured to estimate a load of the plurality of network resources;
a state unit configured to provide a quality of service status of the network;
a resource allocator configured to:
pre-calculate quality of service parameters within the network based on the load of the plurality of network resources and the quality of service status of the network; and
pre-allocate the plurality of network resources based on the pre-calculated quality of service parameters; and
a router configured to route data packets based on the plurality of pre-allocated network resources,
wherein the modeler, the state unit, and the resource allocator form a first loop, and the modeler, the state unit, and the routing unit form a second loop.

2. The device of claim 1, wherein the modeler, the state unit, the resource allocator, and the router are located in a control plane of the network.

3. The device of claim 1, wherein the pre-allocation of the plurality of network resources comprises distribution of available network resources of at least one link within the network to queues of the at least one link,
wherein each of the queues includes data packets to be transmitted collectively.

4. The device of claim 3, wherein the state unit is configured to calculate a worst case delay for each of the queues.

5. The device of claim 1, wherein the router is configured to route data packets based on the plurality of pre-allocated network resources taking into account quality of service requirements of the data packets.

6. The device of claim 1, wherein the resource allocator is configured to update the pre-allocation of the plurality of network resources when new links are added to the network, existing links are removed, or new links are added to the network and existing links are removed, when the data packets to be transmitted change, or a combination thereof.

7. The device of claim 1, wherein the modeler is configured to estimate the load of the plurality of network resources based on information from the router and based on information from the resource allocator.

8. The device of claim 7, wherein the information from the router includes information on paths being used for the data packets within the network.

9. The device of claim 7, wherein the information from the resource allocator includes information on allocated resources.

10. The device of claim 1, wherein the router is configured to determine a path for the data packets to be routed, the determination of the path comprising minimization of a cost of a path from origin to destination while fulfilling the quality of service requirements of the data packets from origin to destination.

11. The device of claim 10, wherein the quality of service requirements of the data packets from origin to destination are end-to-end quality of service requirements.

12. The device of claim 10, wherein the determination of the path for the data packets to be routed comprises minimization of the cost of the path from origin to destination while fulfilling the quality of service requirements of the data packets for each hop from origin to destination.

13. The device of claim 12, wherein the quality of service requirements of the data packets for each hop from origin to destination are per hop quality of service requirements.

14. A method for managing end-to-end connections of a network within a central network management entity, the network including a plurality of network resources, the method comprising:
estimating a load of the plurality of network resources;
providing a quality of service status of the network;
pre-calculating quality of service parameters within the network based on the load of the plurality of network resources and the quality of service status of the network;
pre-allocating the plurality of network resources based on the pre-calculated quality of service parameters; and
routing data packets based on the plurality of pre-allocated network resources,
wherein the estimating, the providing, the pre-calculating, and the pre-allocating form a first loop, and the estimating-step, the providing, and the routing form a second loop.

15. A non-transitory computer-readable storage medium storing instructions executable by one or more processor for managing end-to-end connections of a network within a central network management entity, the network including a plurality of network resources, the instructions comprising:
estimating a load of the plurality of network resources;
providing a quality of service status of the network;
pre-calculating quality of service parameters within the network based on the load of the plurality of network resources and the quality of service status of the network;
pre-allocating the plurality of network resources based on the pre-calculated quality of service parameters; and
routing data packets based on the plurality of pre-allocated network resources,
wherein the estimating, the providing, the pre-calculating, and the pre-allocating form a first loop, and the estimating, the providing, and the routing form a second loop.

16. The non-transitory computer-readable storage medium of claim 15, wherein pre-allocating the plurality of network resources comprises distributing available network resources of at least one link within the network to queues of the at least one link,
wherein each of the queues includes data packets to be transmitted collectively.

17. The non-transitory computer-readable storage medium of claim 16, further comprising calculating a worst case delay for each of the queues.

18. The non-transitory computer-readable storage medium of claim 15, wherein routing data packets based on the plurality of pre-allocated network resources comprises routing data packets based on the plurality of pre-allocated network resources taking into account quality of service requirements of the data packets.
